(19) United States
(12) Patent Application Publication
(10) Pub. No.: US 2026/0143366 A1
(43) Pub. Date: May 21, 2026

(54) MEASUREMENT SYSTEM FOR OVER-THE-AIR TESTING OF A DEVICE FOR NON-TERRESTRIAL NETWORKS, USER EQUIPMENT, AND METHOD FOR EMULATING AND DETERMINING A POLARIZATION MISMATCH IN NON-TERRESTRIAL COMMUNICATION SYSTEMS

(71) Applicant: Rohde & Schwarz GmbH & Co. KG, Muenchen (DE)

(72) Inventors: Utkarsh RANVEER, New Dehli (IN); Reiner STUHLFAUTH, Muenchen (DE); Niels PETROVIC, Muenchen (DE); Edwin MENZEL, Muenchen (DE); Stefan SCHMIDT, Muenchen (DE); Daniela RADDINO, Muenchen (DE)

(21) Appl. No.: 18/950,982

(22) Filed: Nov. 18, 2024

(51) Int. Cl. H04W 24/06; H04B 7/00

(52) U.S. Cl. CPC H04W 24/06; H04B 7/002

(57) ABSTRACT

A measurement system for over-the-air testing of a device for non-terrestrial networks is described. The measurement system includes an anechoic chamber, at least one transmission antenna configured to transmit a source signal, a polarization rotator configured to rotate a polarization state of the source signal transmitted by the transmission antenna, and an electronic circuit configured to control the polarization rotator such that an ionospheric Faraday rotation is simulated. In addition, a user equipment (UE) is described. The UE is configured to measure a polarization direction of a received signal and to report the measured polarization direction by transmitting it as channel state information. Further, a method for emulating and determining a polarization mismatch in non-terrestrial communication systems is described. The method includes a step of establishing a connection between a system simulator and a device under test, wherein the system simulator indicates the used polarization to the device under test.

### FIELD OF THE DISCLOSURE

Embodiments of the present disclosure relate to a measurement system for over-the-air testing of a device for non-terrestrial networks. Further embodiments relate to user equipment and to a method for emulating and determining a polarization mismatch in non-terrestrial communication systems.

### BACKGROUND

A non-terrestrial network (NTN) is a wireless communication network that relies on satellites or other aerial platforms like high-altitude platform stations (HAPS) or unmanned aerial vehicles (UAV) for carrying base stations or relay nodes. Especially the satellites can be provided in orbits such that the signal transmission is done through the Earth's ionosphere.

The ionosphere is an upper part of the atmosphere that is ionized by solar radiation. A radio wave travelling through the ionosphere is subject to the Faraday effect. The presence of free electrons and the Earth's magnetic field cause a rotation of the polarization state of the radio wave. Therefore, the Faraday effect is also called Faraday rotation.

Ionospheric Faraday rotation may deteriorate signal transmission between satellites and equipment located on the Earth's surface.

Accordingly, there is a need for testing and mitigating the effects of Faraday rotation on the transmission of radio waves.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides examples of a measurement system for over-the-air testing of a device for non-terrestrial networks. In an embodiment, the measurement system comprises an anechoic chamber, at least one transmission antenna configured to transmit a source signal, a polarization rotator configured to rotate a polarization state of the source signal transmitted by the transmission antenna, and an electronic circuit configured to control the polarization rotator such that an ionospheric Faraday rotation is simulated.

Accordingly, the measurement system can simulate the Faraday rotation naturally occurring in the Earth's ionosphere in an anechoic chamber. This allows examining how a tested device would operate under realistic conditions in a non-terrestrial network, e.g. performing real-world tests on a device under test in a laboratory. Especially, it can be tested how the device reacts to a signal that has been subject to Faraday rotation. Moreover, the measurement system allows to test solutions for mitigating adverse effects of Faraday rotation.

In an embodiment, the measurement system can be used for testing a user equipment, i.e. a communication device for an end-user, e.g. a mobile phone or any computing device equipped with a mobile broadband modem. To enable the control of the polarization rotator, a connection (e.g. a wired connection) can be provided between the electronic circuit and the polarization rotator.

In an embodiment, the electronic circuit may be configured to control the polarization rotator such that dynamic effects of the ionospheric Faraday rotation are simulated. Hence, the ionospheric Faraday rotation can be simulated in a particularly accurate manner. Thus, a reliability of testing results provided by the measurement system can be increased.

In an embodiment, the simulated dynamic effects of the ionospheric Faraday rotation may especially comprise temporal variations of an electron density in the ionosphere. The Earth's ionosphere comprises a plasma having free electrons. In the ionosphere, the Faraday effect is caused by the free electrons in combination with the Earth's magnetic field. The strength of the Faraday effect depends on the density of electrons ne. However, the density of electrons in the ionosphere is subject to substantial variations on a daily basis. Besides, the electron density also varies over the solar cycle. By taking into account variations of the electron density, a particularly realistic simulation of the Faraday rotation can be achieved.

For example, the electronic circuit may be configured to generate a random sequence for varying a rotation measure of the simulated Faraday rotation. Hence, dynamic effects (e.g. a varying electron density) of the Faraday rotation can be simulated.

Generally, an overall strength of the ionospheric Faraday rotation is characterized by a rotation measure X. More specifically, the Faraday effect causes the polarization to rotate by an angle of rotation of Ψ=X·λ\hat{ }2. Therein, λ denotes the wavelength of the propagating electromagnetic radiation. The rotation measure X depends on the number density of electrons ne. Therefore, variations of the electron density can be taken into account by varying the rotation measure.

In an embodiment, the polarization rotator may comprise a Faraday rotator. A Faraday rotator is especially a polarization rotator based on the Faraday effect. The polarization of electromagnetic radiation passing through the Faraday rotator can be understood as being rotated due to a difference in the phase velocity between left and right circular polarizations.

The principle of Faraday rotation can also be used in an isolator (Faraday rotation isolator). In this context, an isolator is to be understood as a device that allows transmission of radio frequency power in only one direction. Moreover, a Faraday rotator is the main component of optical isolators, which are devices that allow transmission of light in only one direction.

In an embodiment, the measurement system may further comprise at least one reception antenna configured to receive the source signal. The electronic circuit may be configured to analyze the received source signal. Hence, the effects of the simulated ionospheric Faraday rotation on the source signal can be analyzed. Moreover, the results of the analysis can be used for optimizing transmission of the source signal.

For example, the electronic circuit can be configured to control the transmission antenna such that the source signal is transmitted with a different polarization direction, as a result of which an effect of the simulated Faraday rotation is minimized.

Thus, a solution for mitigating adverse effects of Faraday rotation can be provided. Moreover, the measurement system allows implementing the solution in a testing scenario such that its performance can be evaluated.

Since it operates with a feedback based on the received source signal, the mitigation of adverse effects of the Faraday rotation can be considered as a self-healing of the source signal. The effect of the Faraday rotation on the source signal may be mitigated or at least substantially eliminated.

In an embodiment, the electronic circuit may be configured to adapt the different polarization direction in real-time. This allows an immediate reaction to dynamic effects of the Faraday rotation. Adverse effects of the Faraday rotation can thus be mitigated in a particularly reliable manner.

The present disclosure further provides examples of a method for simulating ionospheric Faraday rotation. In an embodiment, the method comprises: transmitting a source signal via at least one transmission antenna in an anechoic chamber and rotating a polarization state of the transmitted source signal via a polarization rotator provided in the anechoic chamber. Features and advantages described above with regard to the measurement system apply analogously to the method.

In addition, the present disclosure provides examples of a method of operating a non-terrestrial network. In an embodiment, the method comprises: transmitting a signal to a satellite, receiving a signal from the satellite, measuring a polarization direction of the received signal to determine effects of ionospheric Faraday rotation, and controlling a subsequent signal transmission such that effects of the ionospheric Faraday rotation are minimized. Hence, the solution for mitigating effects of Faraday rotation described above (with regard to the measurement system) can be implemented in a real-world scenario. The corresponding advantages and features described above apply analogously (mutatis mutandis).

In an embodiment, the polarization direction of the received signal may be measured by a user equipment or by another component of the non-terrestrial network (NTN), for example by an NTN gateway or by a base station (gNB). The non-terrestrial network may comprises multiple antennas, especially at different angles, for receiving the signal.

The present disclosure further provides examples of a user equipment configured to measure a polarization direction of a received signal and to report the measured polarization direction by transmitting it as channel state information.

Hence, embodiments of the user equipment provide information that can be used to determine if and to which extent a polarization rotation due to the Faraday effect has occurred. The information can be received by another node of the network, especially a base station (e.g. a gNB). In response, the base station can perform corrective measures. For example, the base station may change the polarization direction of the signal transmission to minimize the effect of Faraday rotation (as described above with regard to the measurement system for over-the-air testing of a device for non-terrestrial networks).

In an embodiment, the signal may be received by the user equipment via a phased array antenna of the user equipment. Hence, the polarization direction of the received signal can be measured in a particularly accurate manner.

In addition, the present disclosure provides examples of a method for emulating and determining a polarization mismatch in non-terrestrial communication systems. In an embodiment, the method comprises: establishing a connection between a system simulator and a device under test, wherein the system simulator indicates the used polarization to the device under test and wherein the system simulator changes the used polarization without indicating the change to the device under test, which results in a polarization mismatch in a downlink direction, or wherein the system simulator indicates a changed polarization to the device under test without actually changing the used polarization, which results in a polarization mismatch in the downlink direction.

Thus, operational characteristics of the device under test (DUT) in case of a polarization mismatch can be tested. For example, a block error rate (BLER) may be determined, especially at the DUT side. The connection between the system simulator and the DUT is especially an over-the-air connection. The system simulator may inform the DUT about the changed polarization e.g. via SIB19. The DUT is especially a user equipment.

According to one aspect, the system simulator, for example, may measure a power of an uplink signal after having signaled a correct polarization to the device under test, wherein the system simulator additionally measures a power of an uplink signal after having signaled a wrong polarization to the device under test. This allows testing how the DUT reacts to the polarization signaling performed by the system simulator.

For determining if the device under test applied the polarization indicated by the system simulator correctly, the power measured after having signaled the correct polarization may be, for example, compared to the power measured after having signaled the wrong polarization. It can thus be tested if the DUT is capable of receiving the indicated polarization and of implementing it for signal transmission.

As an example, the method may comprise determining that the device under test used the correct polarization in case the power measured after having signaled the correct polarization is approximately 3 dB higher than the power measured after having signaled the wrong polarization. Hence, a DUT that applies the indicated polarization correctly can be identified.

In other words, the signal after having signaled the wrong polarization would be approximately 3 dB lower. The loss could approach infinity in some cases, depending on the combination of the E-vector of the signal and the antenna polarization of the DUT.

In an embodiment, the system simulator may indicate the used polarization to the device under test by transmitting the information in a SIB19, such that it is tested if the device under test is able to handle polarization information provided in SIB19 correctly. More specifically, if the DUT applies the polarization correctly after receiving the polarization information via a SIB19, it is determined that the DUT handles polarization signaling via SIB19 properly.

The present disclosure further provides examples of a method for determining a polarization used by a device under test. In an embodiment, the method comprises the steps of measuring a phase difference between two receiving antennas of a system simulator and deriving a polarization used by the device under test from the measured phase difference, wherein the two receiving antennas are in cross polarization. Hence, it can be tested how the DUT handles requests for using a particular polarization. For example, it can be tested if the DUT applies an indicated polarization correctly. The remainder of the testing process can be performed as described above with respect to the method for emulating and determining a polarization mismatch in non-terrestrial communication systems.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is an overview schematically illustrating a measurement system according to an embodiment of the present disclosure;

FIG. 2 is an overview schematically illustrating a measurement system according to another embodiment of the present disclosure;

FIG. 3 is an overview schematically illustrating aspects of a measurement system according to an embodiment of the present disclosure;

FIG. 4 is an overview schematically illustrating a user equipment according to an embodiment of the present disclosure;

FIG. 5 is an overview illustrating a setup for emulating and determining a polarization mismatch in non-terrestrial communication systems according to an embodiment of the present disclosure;

FIG. 6 is diagram illustrating in tabular form how different types of polarization mismatch relate to a loss in measured power; and

FIG. 7 is an overview schematically illustrating a moving satellite and a resulting temporal dependence of iononspheric Faraday rotation.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the context of the present disclosure, a non-terrestrial network may especially be understood as a 5G non-terrestrial network, for example as defined in the 3GPP specification 38 series. Satellite access in 5G was first introduced in Release 17 thereof and further integrated in Release 18. Frequency ranges associated with 5G non-terrestrial networks comprise e.g. frequencies between 1525 and 2500 MHz (non-terrestrial Frequency Range 1) as well as between 17.3 to 30.0 GHz (non-terrestrial Frequency Range 2).

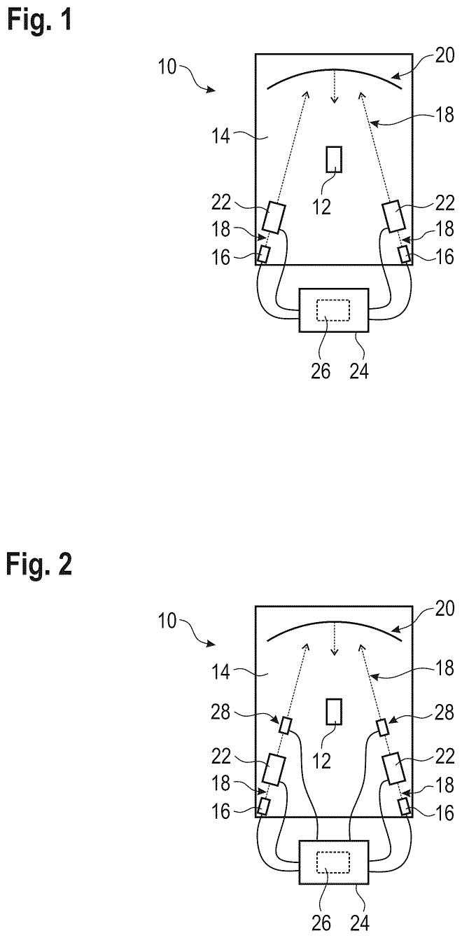

FIG. 1 is an overview schematically illustrating an example of a measurement system 10 for over-the-air testing of a device 12 for non-terrestrial networks (NTNs). As shown in FIG. 1, the measurement system 10 comprises an anechoic chamber 14. The device 12 for non-terrestrial networks is located within the anechoic chamber 14.

In an embodiment, the measurement system 10 further comprises two transmission antennas 16 provided in the anechoic chamber 14. Each of the transmission antennas 16 is configured to transmit a source signal 18. The measurement system 10 may also include an optional reflector 20. If included, the reflector 20 is positioned within the anechoic chamber 14 such that signals impinging on the reflector 20 are reflected towards the device 12. Hence, far-field signals can be simulated in a simplified manner, as the traveling distance is extended by the reflector 20.

In an embodiment, the measurement system 10 further comprises two polarization rotators 22 (one for each of the transmission antennas 16). The polarization rotators 22 are positioned such that the source signals 18 transmitted by the respective transmission antennas 16 in a direction of the reflector 20 traverse the respective polarization rotator 22. The polarization rotators 22 are configured to rotate a polarization state of the source signal 18 transmitted by the transmission antennas 16, for example in a defined manner as will be described hereinafter in more detail.

In the depicted embodiment, the measurement system 10 further comprises a measurement instrument 24 with an electronic circuit 26. A (wired) connection is provided between the measurement instrument 24 and the polarization rotators 22. The electronic circuit 26 is generally configured to control the polarization rotators 22 such that an ionospheric Faraday rotation can be simulated.

Accordingly, the measurement system 10 allows exposing the device 12 to a source signal 18 that has been modified such that Faraday rotation naturally occurring in the Earth's ionosphere is simulated. Thus, it can be examined how the device 12 would operate under realistic conditions in the non-terrestrial network. Especially, it can be tested how the device 12 operates when it receives a signal that has been subject to Faraday rotation.

FIG. 2 is an overview schematically illustrating another embodiment of the measurement system 10 depicted in FIG. 1. In the following, only the differences with respect to FIG. 1 are described.

The measurement system 10 shown in FIG. 2 further comprises two reception antennas 28 which are schematically shown. One reception antenna 28 is provided for each of the transmission antennas 16. The reception antennas 28 are configured to receive the transmitted source signals 18. The reception antennas 28 are positioned such that the source signals 18 that have traversed the polarization rotators 22 are received. A (wired) connection is provided between the reception antennas 28 and the measurement instrument 24.

The electronic circuit 26 is configured to analyze the received source signals 18. More specifically, the effects of the simulated ionospheric Faraday rotation on the source signals 18 is analyzed. In addition, the electronic circuit 26 is configured to control the transmission antennas 16 such that the source signals 18 are transmitted with a different polarization direction, as a result of which an effect of the simulated Faraday rotation is minimized. Thus, a solution for mitigating adverse effects of Faraday rotation can be provided and tested.

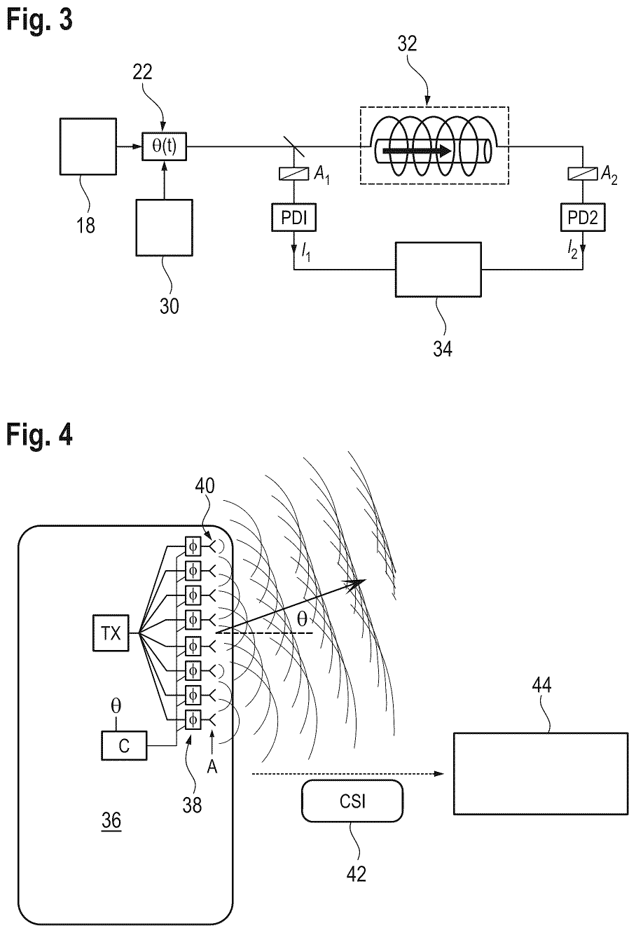

FIG. 3 is an overview schematically illustrating further aspects of the measurement system 10, especially regarding a signal flow. As indicated, the source signal 18 is transmitted to the polarization rotator 22. Via a drive signal 30 that is also transmitted to the polarization rotator 22 for controlling the polarization rotator 22, the amount (i.e. the angle) of polarization rotation can be controlled.

Specifically in a Faraday rotator, the polarization state is rotated in proportion to an applied longitudinal magnetic field. In case of a Faraday rotator, the drive signal 30 thus especially controls the magnetic flux density in the propagation direction of the source signal 18.

After passing through the polarization rotator 22, the (rotated) source signal 18 is measured in a sensing area 32. Subsequently, a signal analysis 34 is performed in order to analyze the effect of the Faraday rotation on the source signal 18.

FIG. 4 is an overview schematically illustrating a user equipment 36. The user equipment 36 comprises a phased array antenna 38 that has a plurality of antenna elements 40. The user equipment 36 is configured to receive a signal via the phased array antenna 38 and to measure a polarization direction of the received signal.

In addition, the user equipment 36 is configured to report the measured polarization direction by transmitting it as channel state information (CSI) 42. The reported polarization direction can be used to detect a polarization rotation caused by the Faraday effect. As a result, a base station 44 can implement corrective measures to mitigate impairments caused by the Faraday effect. For example, the base station 44 may adapt its polarization angle for signal transmission accordingly.

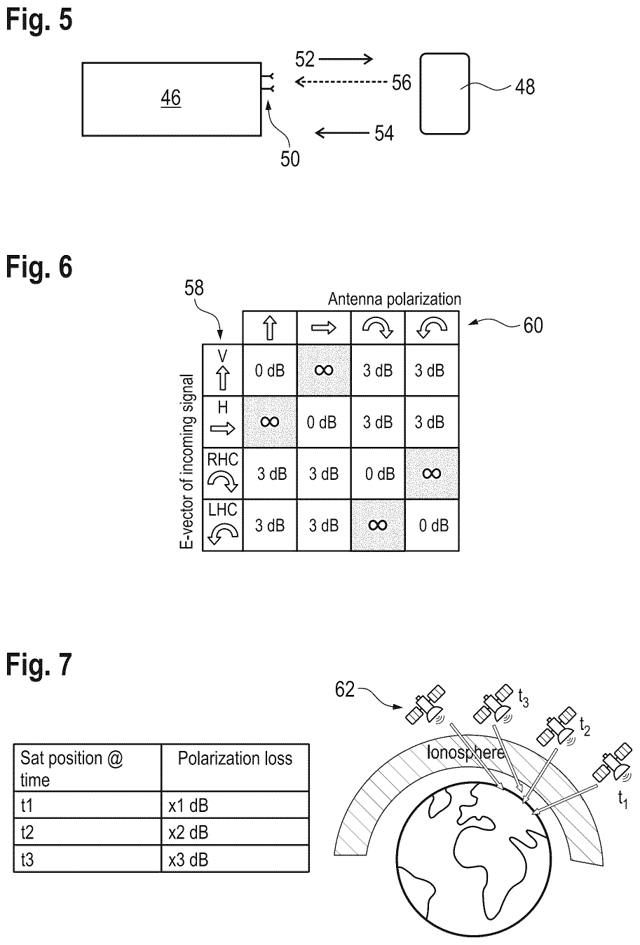

FIG. 5 is an overview schematically illustrating an example of a setup for emulating and determining a polarization mismatch in non-terrestrial communication systems. The setup comprises a system simulator 46 and a device under test 48, e.g. a user equipment. In the depicted example, the system simulator 46 comprises two radio frequency antennas 50.

The setup can be used for performing a method for emulating and determining a polarization mismatch in non-terrestrial communication systems. The method comprises the step of establishing a connection between the system simulator 46 and the device under test 48.

As one option, the system simulator 46 indicates the used polarization to the device under test 48. For example, the system simulator 46 may indicate if the polarization is right-hand circular, left-hand circular, or linear. The information can be provided by the system simulator 46 only for a downlink direction 52 or additionally also for an uplink direction 54. In the former case (i.e. the information for the uplink direction 54 is missing), the device under test 48 assumes that the same polarization direction applies for both directions.

Subsequently, the system simulator 46 changes the used polarization without indicating the change to the device under test 48, which results in a polarization mismatch in the downlink direction 52.

As another option, the system simulator 46 indicates a changed polarization to the device under test 48 without actually changing the used polarization, which likewise results in a polarization mismatch in the downlink direction 52.

In an embodiment, the system simulator 46 measures a power of an uplink signal 56 after having signaled a correct polarization to the device under test 48. Additionally, the system simulator 46 measures a power of an uplink signal 56 after having signaled a wrong polarization to the device under test 48.

For determining if the device under test 48 applied the polarization indicated by the system simulator 46 correctly, the power measured after having signaled the correct polarization is compared to the power measured after having signaled the wrong polarization.

This can be understood in view of FIG. 6 which gives an overview of the resulting power loss for different combinations of polarization mismatch. More specifically, the power loss depends on an E-vector of an incoming signal (i.e. the uplink signal 56) and an antenna polarization of the system simulator 46.

In the first column 58 of the shown table, the polarization direction of the incoming signal is indicated (vertical, horizontal, right-hand circular, or left-hand circular). Likewise, the polarization direction of the system simulator's 46 antenna is indicated in the first row 60 (vertical, horizontal, right-hand circular, or left-hand circular).

As a specific example, if the incoming signal has a right-hand circular polarization and the antenna polarization of the system simulator 46 is vertical, the power loss is approximately 3 dB. Therefore, if the system simulator 46 indicates to the DUT to use right hand circular polarization but measures the incoming signal with a vertically polarized antenna, a power loss of 3 dB will occur, if the DUT applied the indicated polarization correctly.

In this case, if the power measured after having signaled the correct polarization is approximately 3 dB higher than the power measured after having signaled the wrong polarization it can be thus be determined that the DUT used the correct polarization.

FIG. 7 is an overview schematically illustrating a moving satellite 62 and a resulting temporal dependence of iononspheric Faraday rotation. The movement of the satellite 62 results in different values (x1, x2, and x3) of polarization loss (i.e. loss associated with polarization mismatch) at different points in time (t1, t2, and t3) due to the Faraday effect.

A system simulator 46, for example as described above with regard to FIG. 5, may emulate this time-dependence of ionospheric Faraday rotation. The emulation may be based on a calculation of attenuation of downlink signal power. Optionally, the calculated values can be stored for example in a look up table. The calculation may especially take into account a velocity of the satellite 62. The ionospheric Faraday effect can thus be emulated in a particularly realistic manner.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

In an embodiment, one or more of the components, such as the measurement system 10, the user equipment 36, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A measurement system for over-the-air testing of a device for non-terrestrial networks, comprising: an anechoic chamber, at least one transmission antenna configured to transmit a source signal, a polarization rotator configured to rotate a polarization state of the source signal transmitted by the transmission antenna, and an electronic circuit configured to control the polarization rotator such that an ionospheric Faraday rotation is simulated.

2. The measurement system according to claim 1, wherein the electronic circuit is configured to control the polarization rotator such that dynamic effects of the ionospheric Faraday rotation are simulated.

3. The measurement system according to claim 2, wherein the electronic circuit is configured to generate a random sequence for varying a rotation measure of the simulated Faraday rotation.

4. The measurement system according to claim 1, wherein the polarization rotator comprises a Faraday rotator.

5. The measurement system according to claim 1, further comprising at least one reception antenna configured to receive the source signal, wherein the electronic circuit is configured to analyze the received source signal.

6. The measurement system according to claim 5, wherein the electronic circuit is further configured to control the transmission antenna such that the source signal is transmitted with a different polarization direction, as a result of which an effect of the simulated Faraday rotation is minimized.

7. The measurement system according to claim 6, wherein the electronic circuit is configured to adapt the different polarization direction in real-time.

8. A user equipment, comprising circuitry configured to measure a polarization direction of a received signal and to report the measured polarization direction by transmitting it as channel state information.

9. The user equipment according to claim 8, wherein the signal is received by the user equipment via a phased array antenna of the user equipment.

10. A method for emulating and determining a polarization mismatch in non-terrestrial communication systems, the method comprising: establishing a connection between a system simulator and a device under test, wherein the system simulator indicates the used polarization to the device under test and wherein the system simulator changes the used polarization without indicating the change to the device under test, which results in a polarization mismatch in a downlink direction, or wherein the system simulator indicates a changed polarization to the device under test without actually changing the used polarization, which results in a polarization mismatch in the downlink direction.

11. The method according to claim 10 wherein the system simulator measures a power of an uplink signal after having signaled a correct polarization to the device under test and wherein the system simulator additionally measures a power of an uplink signal after having signaled a wrong polarization to the device under test.

12. The method according to claim 11, wherein for determining if the device under test applied the polarization indicated by the system simulator correctly, the power measured after having signaled the correct polarization is compared to the power measured after having signaled the wrong polarization.

13. The method according to claim 11, further comprising determining that the device under test used the correct polarization in case the power measured after having signaled the correct polarization is approximately 3 dB higher than the power measured after having signaled the wrong polarization.

14. The method according to claim 10, wherein the system simulator indicates the used polarization to the device under test by transmitting the information in a SIB19, such that it is tested if the device under test is able to handle polarization information provided in SIB19 correctly.
